(19) United States
(12) Patent Application Publication
(10) Pub. No.: US 2003/0080925 A1
(43) Pub. Date: May 1, 2003

(54) Plasma display panel, and apparatus and method for driving the same

(75) Inventor: Jun-Young Lee, Cheonan-city (KR)

Correspondence Address: McGuire Woods, Suite 1800, 1750 Tysons Boulevard, McLean, VA, 22102-4215, US

(73) Assignee: Samsung SDI Co., Ltd.

(21) Appl. No.: 10/200,486

(22) Filed: Jul. 23, 2002

(30) Foreign Application Priority Data
Oct. 29, 2001 (KR) 2001-066861

(51) Int. Cl. G09G 3/28

(52) U.S. Cl. 345/60

(57) ABSTRACT

A PDP driving apparatus includes a sustain discharge unit including a first switch and a second switch connected between a first voltage and second voltage and having a contact connected to one terminal of a panel capacitor, and a third switch and a fourth switch connected between the voltages and having a contact connected to other terminal of the panel capacitor, for maintaining either terminal voltage at the first voltage or the second voltage; and a charge/discharge unit including a first inductor and a second inductor connected to the terminals of the panel capacitor, for boosting a current to a level to store energy in the first inductor and the second inductor while either terminal voltage of the panel capacitor is maintained at the sustain discharge voltage, and inverting the polarity of either terminal voltage using the stored energy.

### BACKGROUND OF THE INVENTION

(a) Field of the Invention

The present invention relates to a plasma display panel (PDP) and an apparatus and method for driving the same. More specifically, the present invention relates to an energy recovery circuit and a method for driving the same that directly contribute to plasma display discharge.

(b) Description of the Related Art

In recent years, flat panel displays such as liquid crystal displays (LCD), field emission displays (FED), PDPs, and the like have been actively developed. The PDP has advantages over the other flat panel displays because of its high luminance, high luminous efficiency, and wide view angle. Accordingly, the PDP is a preferred large-scale screen of larger than 40 inches that can substitute for the conventional display.

The PDP is a flat panel display that uses plasma generated by gas discharge to display characters or images. It includes, depending on its size, more than several scores to millions of pixels arranged in a matrix pattern. Such a PDP is classified as a direct current (DC) type or an alternating current (AC) type according to its discharge cell structure and the waveform of the driving voltage applied thereto.

The DC type PDP has electrodes exposed to a discharge space to allow DC to flow through the discharge space while the voltage is applied, and thus requires a resistance for limiting the current. To the contrary, the AC type PDP has electrodes covered with a dielectric layer that forms a capacitor to limit the current and protect the electrodes from the impact of ions during discharge. Thus, the AC type PDP has a longer lifetime than the DC type PDP.

FIG. 1 is a partial perspective view of an AC type PDP.

Referring to FIG. 1, on a first glass substrate 1 are arranged in parallel pairs of scan electrodes 4 and sustain electrodes 5 that are covered with a dielectric layer 2 and a protective layer 3. On a second glass substrate 6 are arranged a plurality of address electrodes 8 covered with an insulating layer 7. Barrier ribs 9 are formed in parallel with the address electrodes 8 on the insulating layer 7, which is interposed between the address electrodes 8. A fluorescent material 10 is formed on the surface of the insulating layer 7 and on both sides of the barrier ribs 9. The first and second glass substrates 1 and 6 are arranged face-to-face with a discharge space 11 formed therebetween, and the scan electrodes 4 and the sustain electrodes 5 lie normal to the address electrodes 8. The discharge space at the intersection between the address electrode 8 and the pair of scan electrode 4 and sustain electrode 5 forms a discharge cell 12.

FIG. 2 shows an arrangement of electrodes in the PDP.

Referring to FIG. 2, the PDP has a pixel matrix consisting of m×n discharge cells. In the PDP, address electrodes A₁ to Aₘ are arranged in columns and scan electrodes Y₁ to Yₙ and sustain electrodes X₁ to Xₙ are alternately arranged in rows. Discharge cells 12 shown in FIG. 2 correspond to the discharge cells 12 in FIG. 1.

Typically, the driving method of the AC type PDP is composed of a reset (initialization) step, a write (addressing) step, a sustain step, and an erase step.

In the reset step, the state of each cell is initialized to be ready for addressing the cell. In the write step, wall charges are applied in a selected cell that is on the panel (i.e., addressed cell). In the sustain step, a discharge occurs to actually display an image on the addressed cells. In the erase step, the wall charges on the cells are erased to finish the sustained discharge.

In the AC type PDP, the scan electrodes (hereinafter, referred to as “Y electrodes”) and the sustain electrodes (hereinafter, referred to as “X electrodes”) for the sustain discharge act as a capacitive load, so that there is a capacitance for the electrodes and a need for a reactive power as well as a power for a discharge. A circuit for recovering the reactive power and reusing it is called an “energy recovery circuit (or a sustain discharge circuit)”.

A conventional energy recovery circuit for the AC type PDP and its driving method are now described.

FIGS. 3 and 4 show a conventional energy recovery circuit and its waveform diagram, respectively.

FIG. 3 shows the energy recovery circuit disclosed in the U.S. Pat. Nos. 4,866,349 and 5,081,400 issued to L. F. Weber. The driver circuit for the AC type PDP includes an energy recovery circuit 10 of X electrodes that has the same configuration as an energy recovery circuit 11 (not shown) of Y electrodes. Expediently, the energy recovery circuit for one electrode will be described hereinafter.

The conventional energy recovery circuit 10 includes an energy recovery unit that comprises two switches Sₐ and S_{b}, diodes D₁ and D₂, an inductor L_{C} and an energy recovery capacitor C_{C}, and a sustain discharge unit that comprises two serially connected switches S_{c} and S_{d}.

A contact between the two switches S_{c} and S_{d} of the sustain discharge unit is coupled to the PDP, which is represented by a capacitor C_{P} in an equivalent circuit.

The conventional energy recovery circuit as constructed above operates in four modes according to the states of the switches Sₐ to S_{d}, and shows the waveforms of output voltage V_{P} and current I_{L} flowing to the inductor L_{C}, as illustrated in FIG. 4.

The switch S_{d} is initially ON before the switch Sₐ is turned ON, so that the terminal voltage V_{P} of the panel is at zero. In the meantime, the energy recovery capacitor C_{C} is already charged with a voltage (V_{S}/2) that is half the sustain discharge voltage V_{S}, lest an inrush current be generated at the start of a sustain discharge.

At t0, while the terminal voltage V_{P} of the panel is maintained at zero, the mode 1 begins to turn the switch Sₐ ON and the switches S_{b}, S_{c} and S_{d} OFF.

In the operational interval (t0 to t1) of mode 1, an LC resonance path is formed in sequence of energy recovery capacitor C_{C}, switch Sₐ, diode D₁, inductor L_{C}, and plasma panel capacitor C_{P}. Accordingly, the current I_{L} flowing to the inductor L_{C} forms a half waveform because of LC resonance, and the output voltage V_{P} of the panel gradually increases to the sustain discharge voltage V_{S}. The moment that the output voltage V_{P} of the panel reaches the sustain discharge voltage V_{S}, almost no current flows to the inductor L_{C}.

The mode 2 begins at the end of the mode 1, to turn the switches Sₐ and S_{c} ON and the switches S_{b} and S_{d} OFF. In the operational interval (t1 to t2) of mode 2, the sustain discharge voltage V_{S} is applied to the panel capacitor C_{P} via the switch S_{c} to maintain the output voltage V_{P} of the panel. At t1, zero-voltage switching occurs because the terminal voltage of the switch S_{c} is ideally zero.

Once the mode 2 ends, the mode 3 begins to turn the switch S_{b} ON and the switches Sₐ, S_{c} and S_{d} OFF.

In the operational interval (t2 to t3) of mode 3, an LC resonance path is formed in reverse path of the LC resonance path in mode 1, i.e., a current path including plasma panel capacitor C_{P}, inductor L_{C}, diode D₂, switch S_{b}, and energy recovery capacitor C_{C} in sequence. Accordingly, as shown in FIG. 4, the current I_{L} flows to the inductor L_{C} and the output voltage V_{P} of the panel falls, so that the current I_{L} of the inductor L_{C} and the output voltage V_{P} of the panel reach zero at t3.

In the operational interval of mode 4, the switches S_{b} and S_{d} are turned ON and the switches Sₐ and S_{c} are OFF to maintain the output voltage V_{P} of the panel at zero. Once the switch Sₐ is ON in this state, the cycle returns to mode 1.

Such a conventional energy recovery circuit, however, causes a problem because it is impossible to perform zero-voltage switching of the switches constituting the circuit due to the parasitic components of the actual circuit (e.g., the parasitic resistance of the inductor, the parasitic resistance of the capacitor and the panel, or resistance of the switches) with a consequence of a great switching loss while the switch is on. In other words, the magnetic energy stored in the inductor L_{C} is ideally zero in the conventional energy recovery circuit when the voltage at one terminal of the panel capacitor is increased by the sustain discharge voltage V_{S}. Thus, there is no source to raise the voltage at the terminal of the panel capacitor to V_{S}, if the voltage at the one terminal of the panel capacitor does not reach V_{S} due to the parasitic components of the actual circuit. Accordingly, the actual switch S_{C} is not capable of zero-voltage switching to increase a switching loss when it is turned on.

Also, the energy recovery capacitor C_{C} of the conventional energy recovery circuit has to be charged with V_{S}/2 after starting discharge. Otherwise, a great inrush current is generated at the start of a sustain discharge pulse, which may require a protective circuit to reduce the inrush current.

Furthermore, a long period of rising/falling time of the panel voltage in the conventional energy recovery circuit may cause a discharge of the panel during the energy recovery interval (i.e., the rising/falling interval of the panel voltage). This may drop the panel voltage to cause a hard switching of the sustain switch S_{C} and hence a great switching loss when the switch is turned on.

### SUMMARY OF THE INVENTION

It is an object of the present invention to provide an apparatus and a method for driving a plasma display panel (PDP) that allows zero-voltage switching despite the parasitic components of the actual circuit.

It is another object of the present invention to provide an apparatus and a method for driving a PDP that reduces an inrush current at the start of a sustain discharge.

It is further another object of the present invention to provide an apparatus and a method for driving a PDP that reduces the rising/falling time of a panel voltage to allow a discharge in the sustain interval.

In one aspect of the present invention, an apparatus for driving a plasma display panel, in which pairs of scan electrodes and pairs of sustain electrodes are alternately disposed and a panel capacitor is formed between the scan electrode and the sustain electrode, comprises a sustain discharge unit comprising first and second switches serially connected between first and second voltages and having a contact connected to one terminal of the panel capacitor, and third and fourth switches serially connected between the first and second voltages and having a contact connected to another terminal of the panel capacitor, the sustain discharge unit maintaining either terminal voltage of the panel capacitor at the first or second voltage; a first charge/discharge unit comprising first and second capacitors serially connected between the first and second voltages, fifth and sixth switches each connected in parallel to a contact between the first and second capacitors, and a first inductor connected to a contact between the fifth and sixth switches and to the one terminal of the panel capacitor, the first charge/discharge unit charging the one terminal of the panel capacitor to the first voltage or discharging it to the second voltage; and a second charge/discharge unit comprising third and fourth capacitors serially connected between the first and second voltages, seventh and eighth switches each connected in parallel to a contact between the third and fourth capacitors, and a second inductor connected to a contact between the seventh and eighth switches and to the other terminal of the panel capacitor, the second charge/discharge unit charging the other terminal of the panel capacitor to the first voltage or discharging it to the second voltage.

In another aspect of the present invention, an apparatus for driving a plasma display panel, in which pairs of scan electrodes and pairs of sustain electrodes are alternately disposed and a panel capacitor is formed between the scan electrode and the sustain electrode, comprises: a sustain discharge unit comprising first and second switches serially connected between first and second voltages and having a contact connected to the one terminal of the panel capacitor, and third and fourth switches serially connected between the first and second voltages and having a contact connected to the other terminal of the panel capacitor, the sustain discharge unit maintaining either terminal voltage of the panel capacitor at the first or second voltage; a first charge/discharge unit comprising a first capacitor and a first variable voltage serially connected between the first and second voltages, fifth and sixth switches each connected in parallel to a contact between the first capacitor and the first variable voltage, and a first inductor connected to a contact between the fifth and sixth switches and to one terminal of the panel capacitor, the first charge/discharge unit charging the one terminal of the panel capacitor to the first voltage or discharging it to the second voltage; and a second charge/discharge unit comprising a second capacitor and a second variable voltage serially connected between the first and second voltages, seventh and eighth switches each connected in parallel to a contact between the second capacitor and the second variable voltage, and a second inductor connected to a contact between the seventh and eighth switches and to the other terminal of the panel capacitor, the second charge/discharge unit charging another terminal of the panel capacitor to the first voltage or discharging it to the second voltage.

In still another aspect of the present invention, an apparatus for driving a plasma display panel, in which pairs of scan electrodes and pairs of sustain electrodes are alternately disposed and a panel capacitor is formed between the scan electrode and the sustain electrode, comprises: a sustain discharge unit comprising first and second switches serially connected between first and second voltages and having a contact connected to one terminal of the panel capacitor, and third and fourth switches serially connected between the first and second voltages and having a contact connected to an other terminal of the panel capacitor, the sustain discharge unit maintaining either terminal voltage of the panel capacitor at the first or second voltage; and a charge/discharge unit comprising first and second inductors electrically connected to the one terminal and the other terminal of the panel capacitor, respectively, the charge/discharge unit boosting a current to store an energy in the first and second inductors while either terminal voltage of the panel capacitor is maintained at a sustain discharge voltage, the charge/discharge unit inverting the polarity of either terminal voltage of the panel capacitor using the energy stored in the first and second lo inductors.

In further another aspect of the present invention, a plasma display panel comprises: a panel comprising a plurality of address electrodes, a plurality of pairs of scan electrodes and pairs of sustain electrodes alternately arranged, and a panel capacitor formed between the scan electrode and the sustain electrode; a controller for receiving an external image signal, and generating an address drive control signal and a sustain discharge signal; an address driver for receiving the address drive control signal from the controller, and applying to the address electrodes a display data signal for selection of discharge cells to be displayed; and a scan/sustain driver for receiving the sustain discharge signal from the controller, and applying a sustain discharge voltage alternately to the scan electrodes and the sustain electrodes to perform a sustain discharge on the selected discharge cells, wherein the scan/sustain driver comprises: a sustain discharge unit comprising first and second switches serially connected between first and second voltages and having a contact connected to the one terminal of the panel capacitor, and third and fourth switches serially connected between the first and second voltages and having a contact connected to the other terminal of the panel capacitor, the sustain discharge unit maintaining either terminal voltage of the panel capacitor at the first or second voltage; and a charge/discharge unit comprising first and second inductors electrically connected to the one terminal and the other terminal of the panel capacitor, respectively, the charge/discharge unit boosting a current to a predetermined level for a later sustain discharge to store an energy in the first and second inductors while either terminal voltage of the panel capacitor is maintained at the sustain discharge voltage, the charge/discharge unit inverting the polarity of either terminal voltage of the panel capacitor using the energy stored in the first and second inductors.

In still further another aspect of the present invention, a method for driving a plasma display panel, in which pairs of scan electrodes and pairs of sustain electrodes are alternately disposed and a panel capacitor is formed between the scan electrode and the sustain electrode, comprises: (a) boosting a current flowing to first and second inductors electrically connected to one terminal and another terminal of the panel capacitor, respectively, to store an energy in the first and second inductors, while either terminal voltage of the panel capacitor is maintained at a sustain discharge voltage having a first polarity; (b) inverting the polarity of either terminal voltage of the panel capacitor using the energy stored in the first and second inductors; (c) recovering the energy stored in the first and second inductors while either terminal voltage of the panel capacitor is changed to a sustain discharge voltage having a second polarity opposite to the first polarity; and (d) maintaining either terminal voltage of the panel capacitor at the sustain discharge voltage having the second polarity.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 is a partial perspective of an AC type PDP.

FIG. 2 illustrates an arrangement of electrodes in the PDP.

FIGS. 3 and 4 illustrate conventional energy recovery circuit and its driving waveform, respectively.

FIG. 5 illustrates a PDP in accordance with an embodiment of the present invention.

FIG. 6 illustrates an energy recovery circuit in accordance with an embodiment of the present invention.

FIGS. 7A, 7B, 7C, 7D, 7E, 7F, 7G and 7H illustrate the individual operation modes of the energy recovery circuit shown in FIG. 6.

FIG. 8 illustrates a timing diagram in accordance with a first embodiment of the present invention.

FIG. 9 illustrates the charging/discharging current of inductors in accordance with the first embodiment of the present invention.

FIG. 10 illustrates a timing diagram in accordance with a second embodiment of the present invention.

FIG. 11 illustrates the charging/discharging current of inductors in accordance with the second embodiment of the present invention.

FIG. 12 illustrates an operational timing in accordance with a third embodiment of the present invention.

FIG. 13 illustrates the charging/discharging current of inductors in accordance with the third embodiment of the present invention.

FIG. 14 illustrates an energy recovery circuit in accordance with a fourth embodiment of the present invention.

FIG. 15 illustrates an energy recovery circuit in accordance with a fifth embodiment of the present invention.

FIGS. 16A, 16B, 16C, 16D, 16E, 16F, 16G and 16H illustrate the individual operation modes of the energy recovery circuit shown in FIG. 15.FIG. 17 illustrates the equivalent circuit of mode 2 in accordance with embodiment of the present invention.

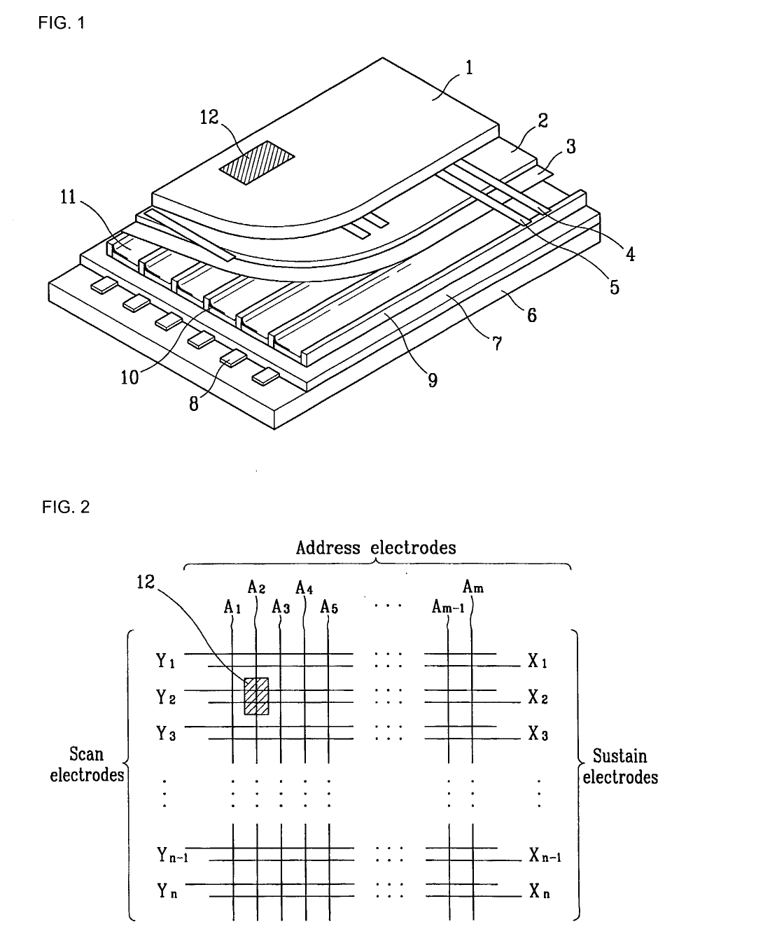

### DETAILED DESCRIPTION OF THE PREFERRED EMBODIMENTS

In the following detailed description, only the preferred embodiment of the invention has been shown and described, simply by illustrating the best mode contemplated by the inventor of carrying out the invention. As will be realized, the invention is capable of modification in various obvious respects, all without departing from the invention. Accordingly, the drawings and description are to be regarded as illustrative in nature, and not restrictive.

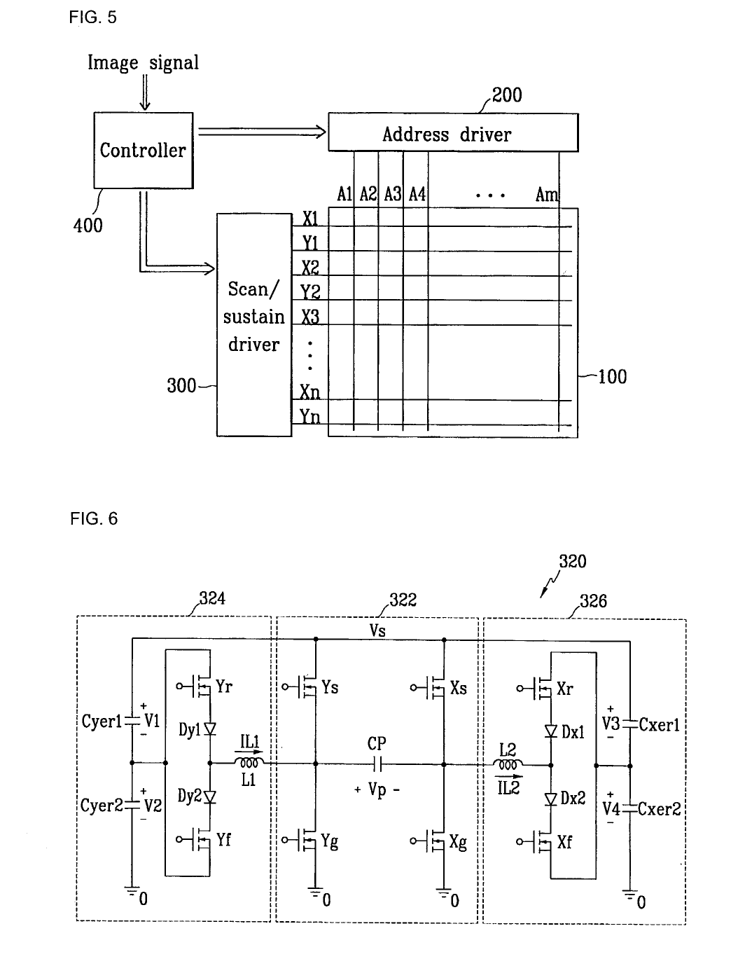

FIG. 5 illustrates a plasma display panel (PDP) in accordance with an embodiment of the present invention.

Referring to FIG. 5, the PDP according to the embodiment of the present invention comprises a plasma panel 100, an address driver 200, a scan/sustain driver 300, and a controller 400.

The plasma panel 100 comprises a plurality of address electrodes A₁ to Aₘ arranged in columns and a plurality of scan electrodes Y₁ to Yₙ and sustain electrodes X₁ to Xₙ alternately arranged in rows.

The address driver 200 receives an address drive control signal from the controller 400 and applies to the individual address electrodes a display data signal to select discharge cells for display.

The scan/sustain driver 300 receives a sustain discharge signal from the controller 400 and applies a sustain pulse voltage alternately to the scan electrodes and the sustain electrodes for a sustain discharge on the selected discharge cells.

The controller 400 receives an external image signal, generates the address drive control signal and the sustain discharge signal, and applies them to the address driver 200 and the scan/sustain driver 300, respectively.

The scan/sustain driver 300 according to the embodiment of the present invention includes an energy recovery circuit for recovering a reactive power and reusing it. FIG. 6 illustrates an energy recovery circuit 320 in accordance with a first embodiment of the present invention.

As illustrated in FIG. 6, the energy recovery circuit 320 according to the embodiment of the present invention comprises a sustain discharge unit 322, a Y electrode charge/discharge unit 324, and an X electrode charge/discharge unit 326.

The sustain discharge unit 322 comprises four sustain switches Yₛ, Y_{g}, Xₛ and X_{g}, each of which is composed of a MOSFET that has a body diode connected to a sustain discharge voltage V_{S} or a ground voltage. The switching operations of these four switches allow the terminal voltages V_{y} and Vₓ of panel capacitor C_{P} to be maintained at the sustain discharge voltage V_{S} or the ground voltage.

The Y electrode charge/discharge unit 324 comprises energy recovery capacitors C_{yer1} and C_{yer2} serially connected between the sustain discharge voltage V_{S} and the ground voltage; energy recovery switches Yᵣ and Y_{f} connected in parallel to a contact between the capacitors C_{yer1} and C_{yer2} in order to raise or drop the terminal voltage V_{P} of the panel capacitor C_{P}; and an inductor L₁ formed between the contact between the energy recovery switches Yᵣ and Y_{f} and the panel capacitor C_{P}. The Y electrode charge/discharge unit 324 may further comprise diodes D_{y1} and D_{y2} connected to the switches Yᵣ and Y_{f}, respectively, for determining a path for current supply to the panel capacitor C_{P} and a path for current recovery from the panel capacitor C_{P}. The Y electrode charge/discharge unit 324 charges the Y electrodes of the panel capacitor to the sustain discharge voltage V_{S} or discharges such voltage to the ground voltage.

The X electrode charge/discharge unit 326 comprises energy recovery capacitors Cₓₑᵣ₁ and Cₓₑᵣ₂ serially connected between the sustain discharge voltage V_{S} and the ground voltage; energy recovery switches Xᵣ and X_{f} connected in parallel to a contact between the capacitors Cₓₑᵣ₁ and Cₓₑᵣ₂ in order to raise or drop the terminal voltage V_{P} of the panel capacitor C_{P}; and an inductor L₂ formed between the contact between the energy recovery switches Xᵣ and X_{f} and the panel capacitor C_{P}. The X electrode charge/discharge unit 326 may further comprise diodes Dₓ₁ and Dₓ₂ connected to the switches Xᵣ and X_{f}, respectively, for determining a path for current supply to the panel capacitor C_{P} and a path for current recovery from the panel capacitor C_{P}. The X electrode charge/discharge unit 326 charges the X electrodes of the panel capacitor to the sustain discharge voltage V_{S} or discharges such voltage to the ground voltage.

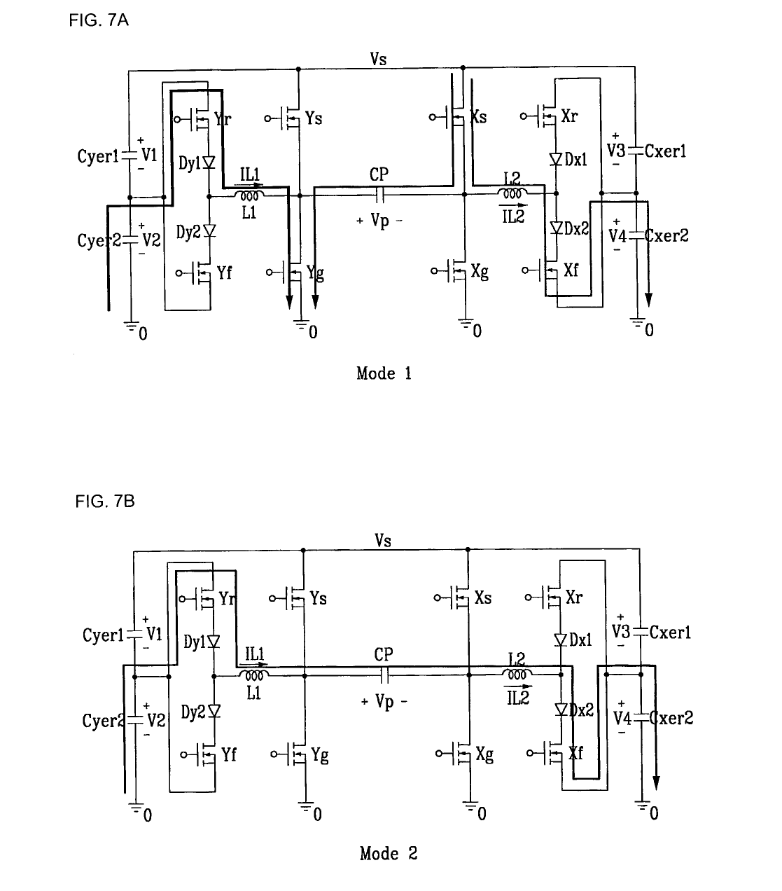

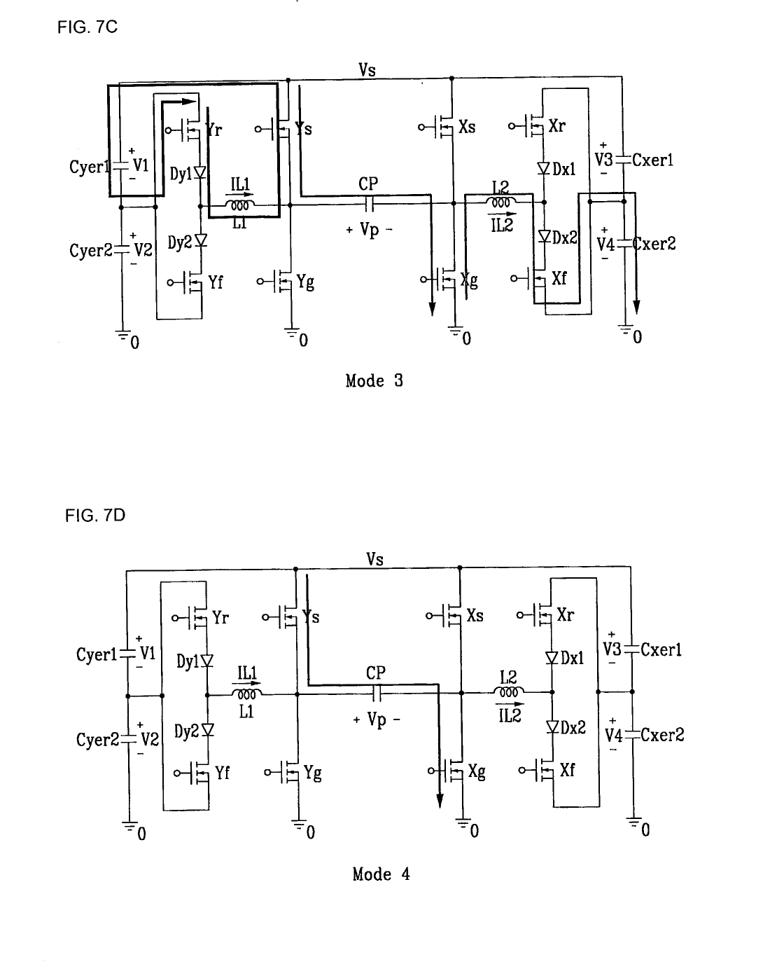

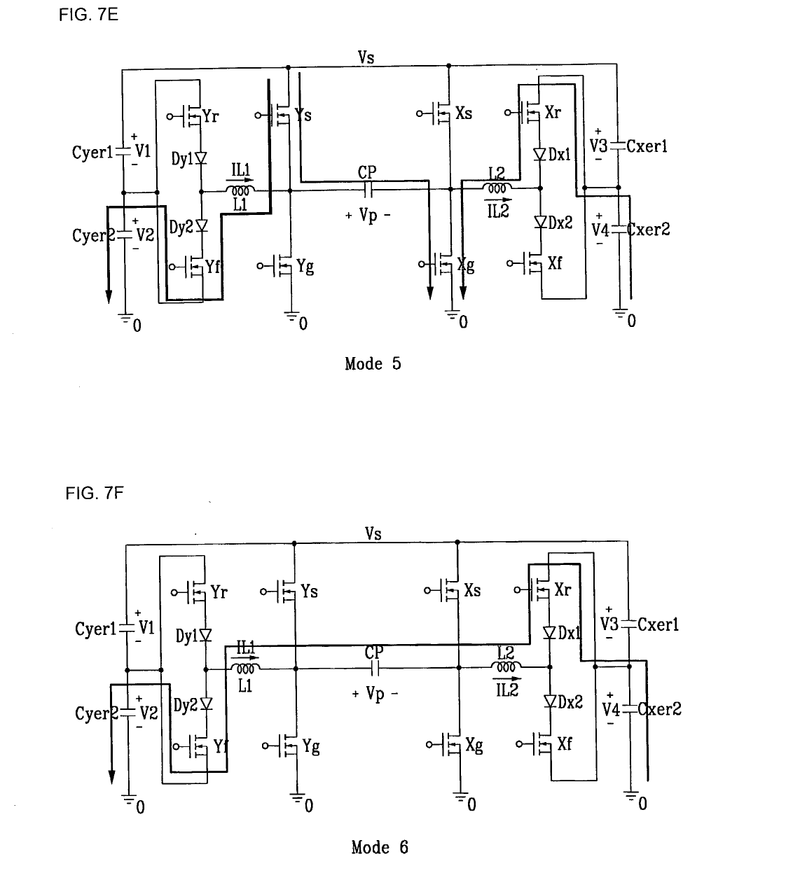

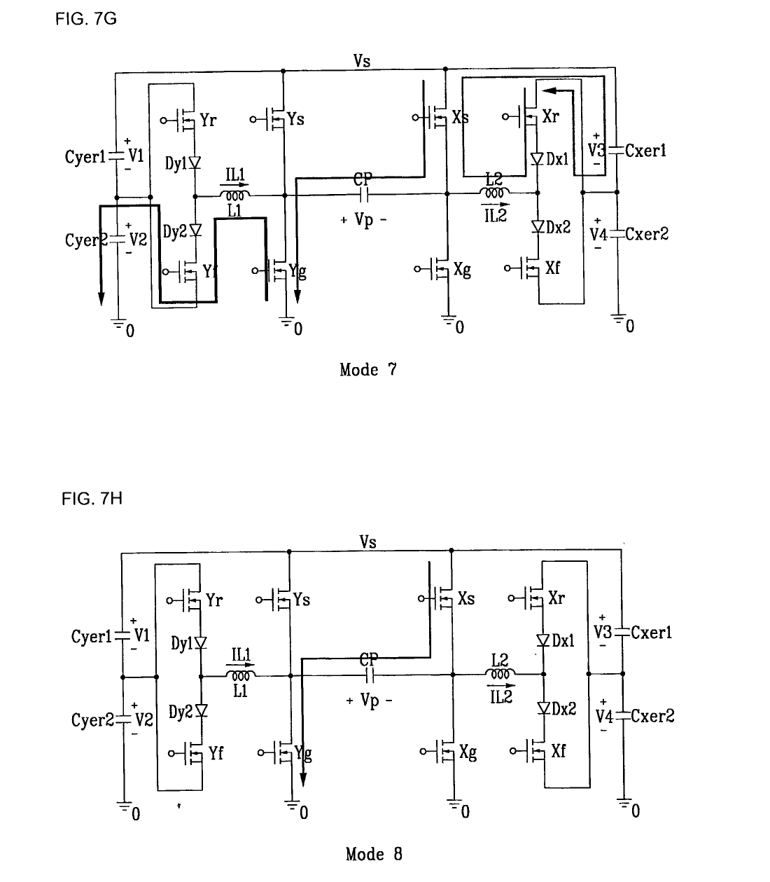

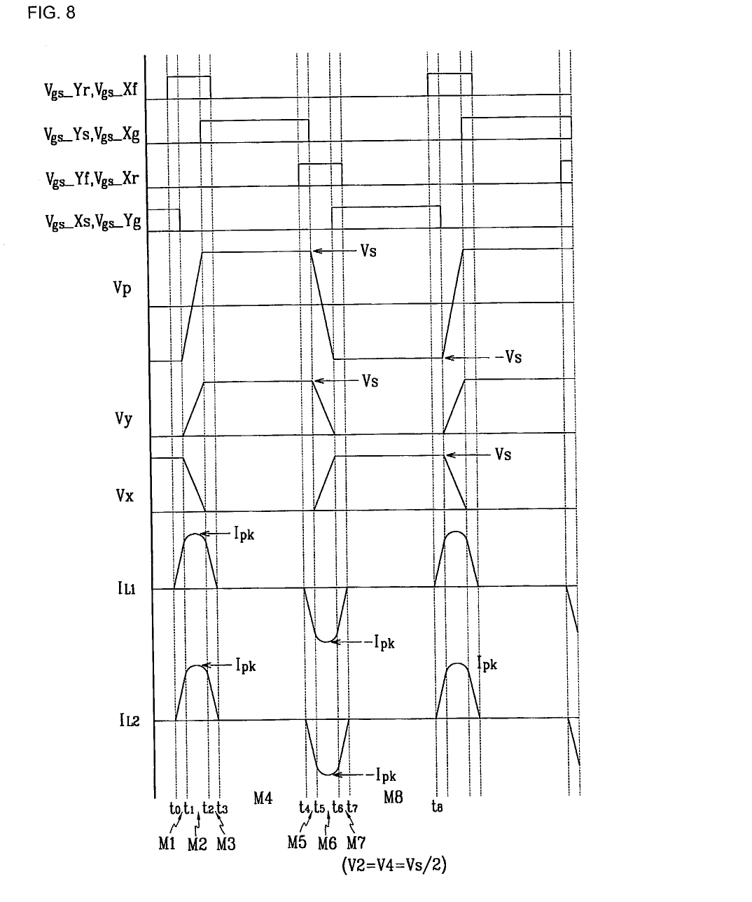

Now, a description will be given to a method for driving the PDP in accordance with the first embodiment of the present invention with reference to FIGS. 7A, 7B, 7C, 7D, 7E, 7F, 7G, 7H and 8.

FIGS. 7A through 7H illustrate the current paths formed in the respective operation modes according to the first embodiment of the present invention, and FIG. 8 is a timing diagram in accordance with the first embodiment of the present invention.

In the first embodiment of the present invention, it is assumed that before the start of mode 1, the switches Y_{g} and Xₛ are ON; C_{yer1}=V1, C_{yer2}=V2, Cₓₑᵣ₁=V3 and Cₓₑᵣ₂=V4; and L₁=L₂=L.

(1) Mode 1 (t0 through t1)

Referring to FIG. 7A, in the interval of mode 1, the switches Yᵣ and X_{f} are turned ON while the switches Y_{g} and Xₛ are ON. Once the switch Yᵣ of the Y electrode charge/discharge unit 324 is turned ON, with the switches Y_{g} and Xₛ ON, there forms a current path including capacitor C_{yer2}, switch Yᵣ, inductor L₁ and switch Y_{g} in sequence, as shown in FIG. 7A. On the other hand, when the switch X_{f} of the X electrode charge/discharge unit 326 is turned ON, there forms a current path including switch Xₛ, inductor L₂, switch X_{f} and capacitor Cₓₑᵣ₂ in sequence. Accordingly, as shown in FIG. 8, currents I_{L1} and I_{L2} flowing to the inductors L₁ and L₂ in mode 1 linearly increase with slopes of V2/L and V3/L, respectively, to store the magnetic energy in the inductors L₁ and L₂.

(2) Mode 2 (t1 through t2)

Referring to FIG. 7B, in the interval of mode 2, the switches Xₛ and Y_{g} are turned OFF while the switches Yᵣ and X_{f} are ON. As a consequence, there forms a current path shown in FIG. 7B that includes capacitor C_{yer2}, switch Yᵣ, inductor L₁, panel capacitor C_{P}, inductor L₂, switch X_{f} and capacitor Cₓₑᵣ₂ in sequence. Accordingly, as shown in FIG. 8, a resonance current caused by the panel capacitance flows to the inductors L₁ and L₂ and the terminal voltage V_{P} of the panel capacitor is inverted in polarity from −V_{S} to V_{S}. That is, in the interval of mode 2, the voltage V_{y} at the Y electrode of the panel capacitor C_{P} rises from the ground voltage to the sustain discharge voltage V_{S} and the voltage Vₓ at the X electrode of the panel capacitor C_{P} drops from the sustain discharge voltage V_{S} to the ground voltage, so that the terminal voltage V_{P} of the panel capacitor is inverted in polarity from —V_{S} to V_{S}.

(3) Mode 3 (t2 through t3)

Referring to FIG. 7C, in the interval of mode 3, the switches Yₛ and X_{g} are turned ON while the switches Yᵣ and X_{f} are ON.

At t=t2, once the voltage V_{y} reaches the sustain discharge voltage V_{S} and the voltage Vₓ reaches the ground voltage, the body diodes of the switches Yₛ and X_{g} are turned ON. As shown in FIG. 8, when the switches Yₛ and X_{g} are ON at the voltage between their drain and source being zero. In other words, when they perform zero-voltage switching, there is no turn-on switching loss. According to the embodiment of the present invention, enough energy is ideally stored in the inductor L₁ even when the voltage at the Y electrode of the panel capacitor reaches the sustain discharge voltage V_{S}, so that the energy at the inductor L₁ allows the voltage at the Y electrode of the panel capacitor to increase to the sustain discharge voltage V_{S}. Hence, the switch Yₛ is capable of zero-voltage switching despite the parasitic components of the circuit.

In the mode 3, as shown in FIG. 8, the terminal voltage V_{P} of the panel is maintained at +V_{S}. The current I_{L1} flowing to the inductor L₁ of the Y electrode charge/discharge unit 324 is linearly decreased to zero with a slope of −V1/L through a current path that includes capacitor C_{yer1}, switch Yᵣ, inductor L₁, the body diode of switch Yₛ and power source V_{S} in sequence. Namely, the energy stored in the inductor L₁ is recovered into the capacitor C_{yer1} via the body diode of the switch Yₛ. The current I_{L2} flowing to the inductor L₂ of the X electrode charge/discharge unit 326 is also linearly decreased to zero with a slope of −V4/L through a current path that includes the body diode of switch X_{g}, inductor L₂, switch X_{f} and capacitor Cₓₑᵣ₂ in sequence. Namely, the energy stored in the inductor L₂ is recovered into the capacitor Cₓₑᵣ₂ via the switch X_{f}.

Here, the negative sign of the currents I_{L1} and I_{L2} flowing to the inductors L₁ and L₂ implies that the currents flow in a direction opposite to the reference direction.

(4) Mode 4 (t3 through t4)

Referring to FIG. 7D, in the interval of mode 4, the switches Yᵣ and X_{f} are turned OFF while the switches Yₛ and X_{g} are ON, and the terminal voltage V_{P} of the panel is maintained at the sustain discharge voltage +V_{S}.

In mode 4, the voltage V_{y} at the Y electrode of the panel capacitor is maintained at V_{S}, the voltage Vₓ at the X electrode of the panel capacitor being maintained at the ground voltage. Hence, the terminal voltage V_{P} of the panel capacitor is maintained at +V_{S} to discharge the panel.

(5) Mode 5 (t4 through t5)

Referring to FIG. 7E, in the interval of mode 5, the switches Y_{f} and Xᵣ are turned ON while the switches Yₛ and X_{g} are ON. Once the switch Y_{f} of the Y electrode charge/discharge unit 324 is turned ON, there forms a current path including switch Yₛ, inductor L₁, switch Y_{f} and capacitor C_{yer2} in sequence. On the other hand, when the switch Xᵣ of the X electrode charge/discharge unit 326 is turned ON, there forms a current path shown in FIG. 7E that includes capacitor Cₓₑᵣ₂, switch Xᵣ, inductor L₂ and switch X_{g} in sequence. Accordingly, as shown in FIG. 8, currents I_{L1} and I_{L2} flowing to the inductors L₁ and L₂ in mode 5 linearly decrease with slopes of −V1/L and −V4/L, respectively, to store the magnetic energy in the inductors L₁ and L₂.

(6) Mode 6 (t5 through t6)

Referring to FIG. 7F, in the interval of mode 6, the switches Yₛ and X_{g} are turned OFF while the switches Xᵣ and Y_{f} are ON. As a consequence, there forms a current path shown in FIG. 7F that includes capacitor Cₓₑᵣ₂, switch Xᵣ, inductor L₂, panel capacitor C_{P}, inductor L₁, switch Y_{f} and capacitor C_{yer2} in sequence. Accordingly, as shown in FIG. 8, a resonance current caused by the panel capacitance flows to the inductors L₁ and L₂ and the terminal voltage V_{P} of the panel capacitor is inverted in polarity from V_{S} to −V_{S}. That is, in the interval of mode 6, the voltage Vₓ at the X electrode of the panel capacitor C_{P} rises from the ground voltage to the sustain discharge voltage V_{S} and the voltage V_{y} at the Y electrode of the panel capacitor C_{P} drops from the sustain discharge voltage V_{S} to the ground voltage, so that the terminal voltage V_{P} of the panel capacitor is inverted in polarity from V_{S} to −V_{S}.

(7) Mode 7 (t6 through t7)

Referring to FIG. 7G, in the interval of mode 7, the switches Xₛ and Y_{g} are turned ON while the switches Xᵣ and Y_{f} are ON.

At t=t6, once the voltage Vₓ reaches the sustain discharge voltage V_{S} and the voltage V_{y} reaches the ground voltage, the body diodes of the switches Xₛ and Y_{g} are turned ON. As shown in FIG. 8, when the switches Xₛ and Y_{g} are ON at the voltage between their drain and source being zero, i.e., when they perform zero-voltage switching, no turn-on switching loss occurs with them.

In the mode 7, as shown in FIG. 8, the terminal voltage V_{P} of the panel is maintained at −V_{S}. The current I_{L1} flowing to the inductor L₁ of the Y electrode charge/discharge unit 324 is linearly increased to zero with a slope of V2/L through a current path that includes the body diode of switch Y_{g}, inductor L₁, switch Y_{f} and capacitor C_{yer2} in sequence. Namely, the energy stored in the inductor L₁ is recovered into the capacitor C_{yer2} via the switch Y_{f}. The current I_{L2} flowing to the inductor L₂ of the X electrode charge/discharge unit 326 is also linearly increased to zero with a slope of V3/L through a current path that includes capacitor Cₓₑᵣ₁, switch Xᵣ, inductor L₂, the body diode of switch Xₛ and power source V_{S} in sequence. Namely, the energy stored in the inductor L₂ is recovered into the capacitor Cₓₑᵣ₁ via the body diode of the switch Xₛ.

(8) Mode 8 (t7 through t8)

Referring to FIG. 7H, in the interval of mode 8, the switches Xᵣ and Y_{f} are turned OFF while the switches Xₛ and Y_{g} are ON, and the terminal voltage V_{P} of the panel is maintained at the sustain discharge voltage −V_{S}.

In mode 8, the voltage Vₓ at the X electrode of the panel capacitor is maintained at V_{S}, the voltage V_{y} at the Y electrode of the panel capacitor being maintained at the ground voltage. Hence, the terminal voltage V_{P} of the panel capacitor is maintained at −V_{S} to illuminate the panel.

According to the first embodiment of the present invention as described above, the currents of the inductors for energy recovery are boosted in modes 1 and 5, that is, before the polarity of the panel capacitor C_{P} is inverted. The boosted currents (energy) are used to invert the polarity of the panel capacitor in modes 2 and 6. In such a way, terminal voltage of the panel capacitor is either raised to the sustain discharge voltage V_{S} or dropped to the ground voltage irrespective of the energy recovery rate. Accordingly, in the first embodiment of the present invention, it is possible to perform zero-voltage switching by using the boosted currents of the inductors.

The energy recovery circuit according to the embodiment of the present invention as shown in FIG. 6 controls the intervals where the gate signals of the energy recovery switches Yᵣ, Y_{f}, Xᵣ and X_{f} overlap those of the sustain switches Yₛ, Y_{g}, Xₛ and X_{g} to regulate the voltage level of the energy recovery capacitors C_{yer1}, C_{yer2}, Cₓₑᵣ₁ and Cₓₑᵣ₂.

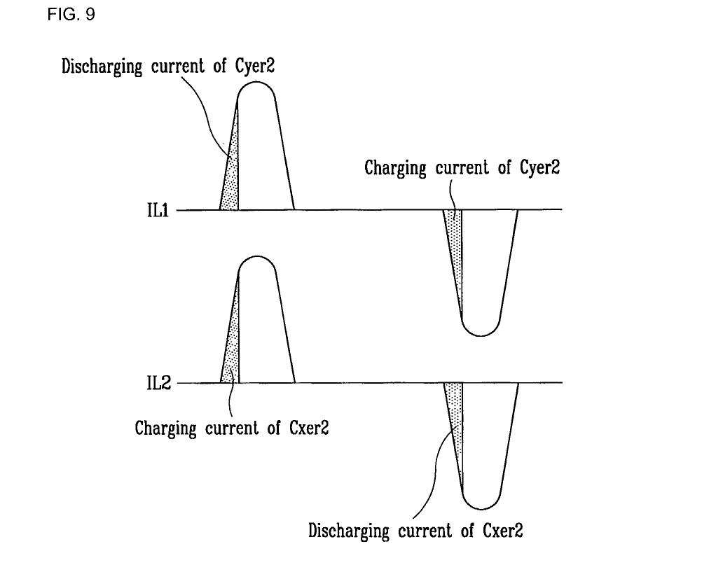

That is, when the interval where the gate signals of the sustain switches Yₛ and X_{g} overlap those of the energy recovery switches Yᵣ, Y_{f}, Xᵣ and X_{f} is equal to the interval where the gate signals of the sustain switches Xₛ and Y_{g} overlap those of the energy recovery switches Yᵣ, Y_{f}, Xᵣ and X_{f}, as shown in FIG. 8 according to the first embodiment of the present invention, the charging/discharging current of the capacitor C_{yer2} becomes equal to that of the capacitor Cₓₑᵣ₂, as shown in FIG. 9. Thus, the terminal voltages V2 and V4 of the respective capacitors C_{yer2} and Cₓₑᵣ₂ are maintained at V_{S}/2. Accordingly, it satisfies V1=V2=V3=V4=V_{S}/2 in the first embodiment of the present invention.

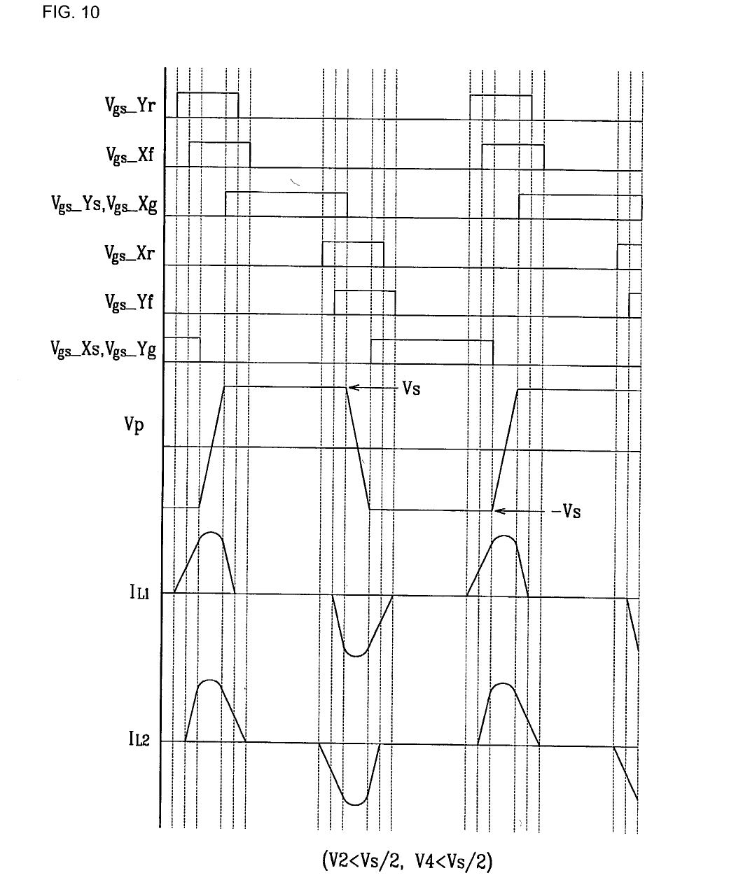

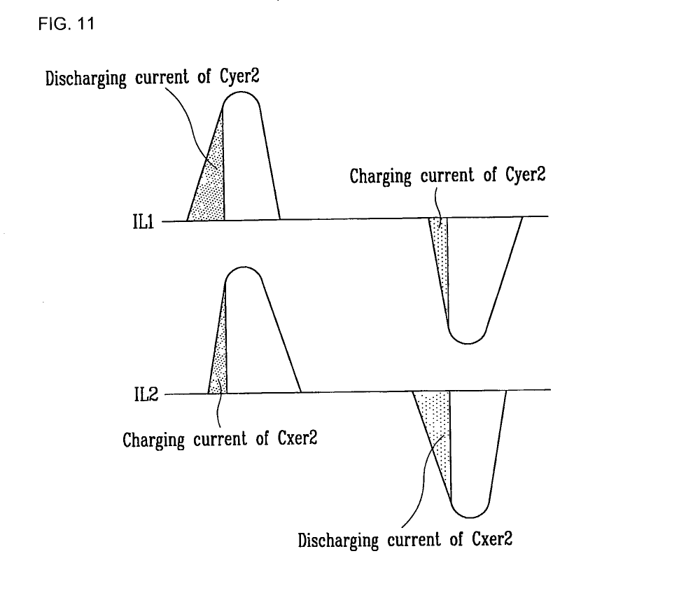

When the interval where the gate signals of the energy recovery switches Yᵣ and Xᵣ overlap those of the sustain switches Yₛ, Y_{g}, Xₛ and X_{g} is longer than the interval where the gate signals of the energy recovery switches Y_{f} and X_{f} overlap those of the sustain switches Yₛ, Y_{g}, Xₛ and X_{g}, as shown in FIG. 10 according to a second embodiment of the present invention, the discharging current of the capacitors C_{yer2} and Cₓₑᵣ₂ becomes higher than their charging current, as shown in FIG. 11. Accordingly, the terminal voltages V2 and V4 of the respective capacitors C_{yer2} and Cₓₑᵣ₂ are below V_{S}/2.

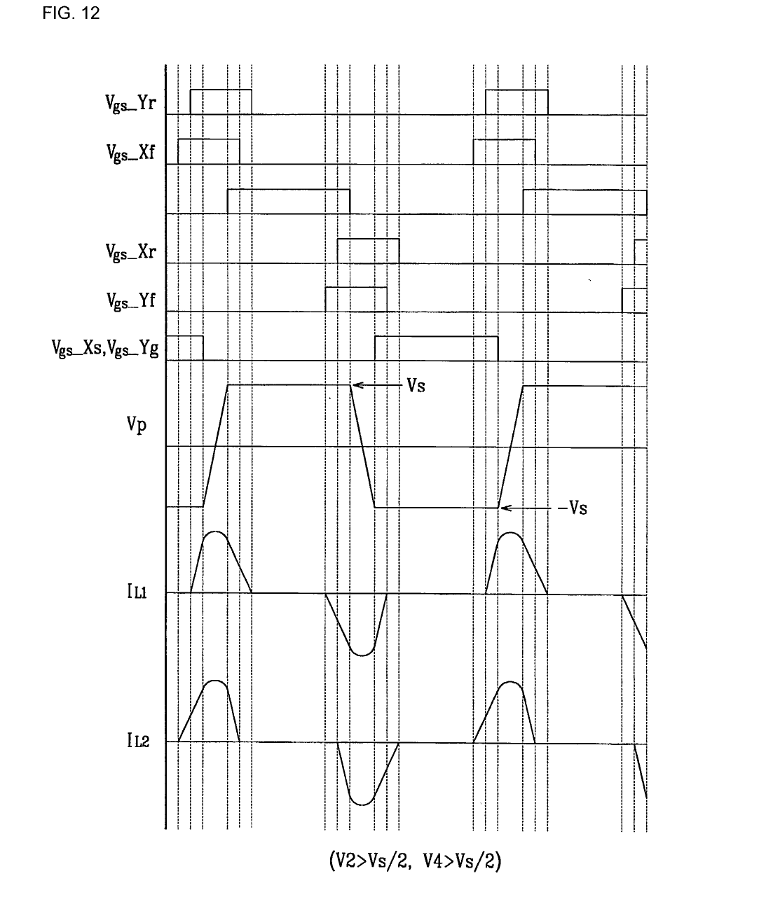

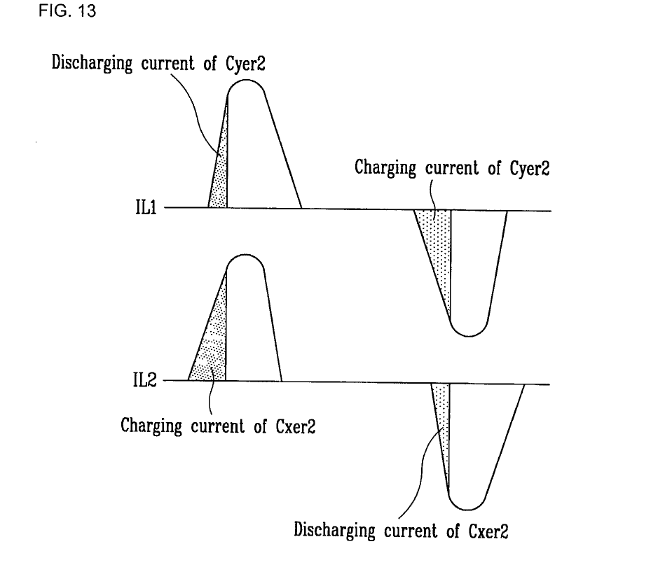

To the contrary, when the interval where the gate signals of the energy recovery switches Yᵣ and Xᵣ overlap those of the sustain switches Yₛ, Y_{g}, Xₛ and X_{g} is shorter than the interval where the gate signals of the energy recovery switches Y_{f} and X_{f} overlap those of the sustain switches Yₛ, Y_{g}, Xₛ and X_{g}, as shown in FIG. 12 according to a third embodiment of the present invention, the discharging current of the capacitors C_{yer2} and Cₓₑᵣ₂ becomes lower than the charging current of them, as shown in FIG. 13. Accordingly, the terminal voltages V2 and V4 of the respective capacitors C_{yer2} and Cₓₑᵣ₂ are above V_{S}/2.

The driving timing diagrams shown in FIGS. 10 and 12 respectively according to the second embodiment and the third embodiment of the present invention use the same circuit as the energy recovery circuit shown in FIG. 6. However, the driving timing of the switches is different. The operation of the energy recovery circuit according to the second embodiment and the third embodiment of the present invention can be understood to those skilled in the art, with reference to FIGS. 6 and 8. Thus, further descriptions are omitted.

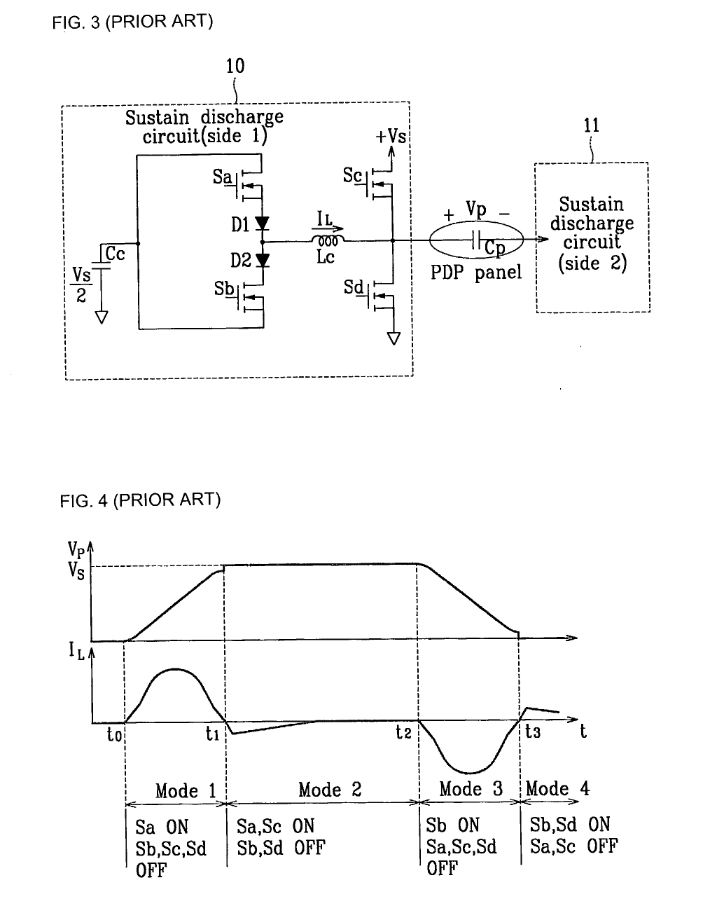

Unlike the conventional energy recovery circuit shown in FIG. 3, the energy recovery circuit shown in FIG. 6 uses the voltages of the energy recovery capacitors only as a power source for boosting the current, and not to maintain the value of the voltage at V_{S}/2.

Although the energy recovery circuit shown in FIG. 6 regulates the voltage levels of the energy recovery capacitors C_{yer1}, C_{yer2}, Cₓₑᵣ₁ and Cₓₑᵣ₂ by controlling the intervals where the gate signals of the energy recovery switches Yᵣ, Y_{f}, Xᵣ and X_{f} overlap those of the sustain switches Yₛ, Y_{g}, Xₛ and X_{g}, the voltage levels can also be regulated in the following manner.

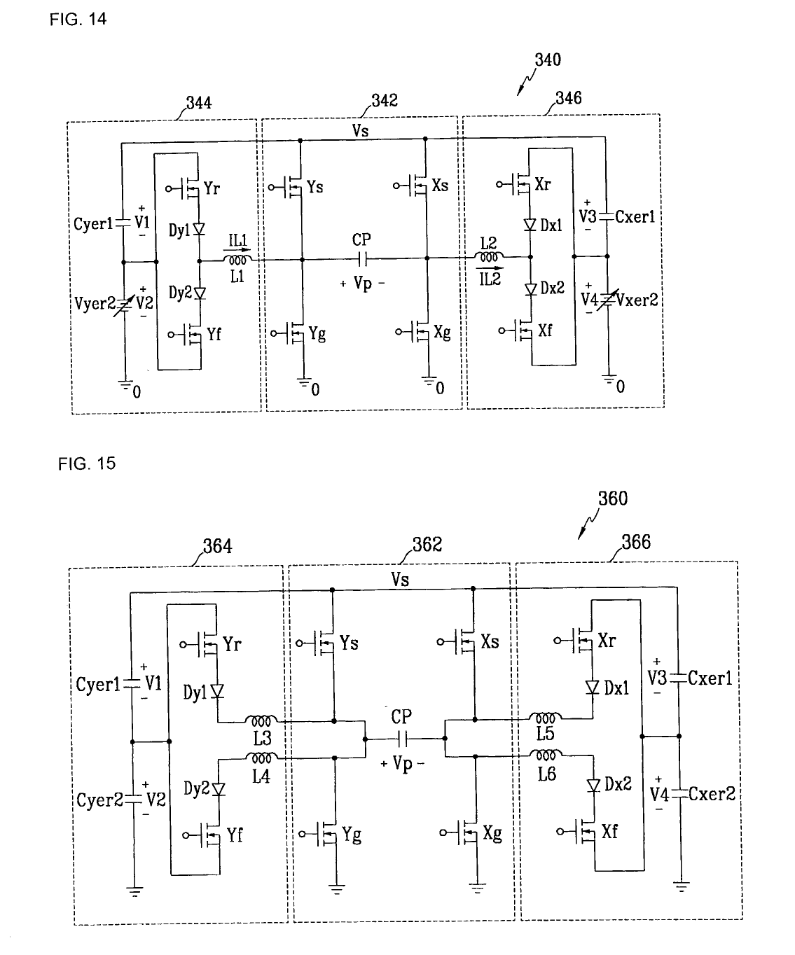

FIG. 14 illustrates an energy recovery circuit 340 according to a fourth embodiment of the present invention. Referring to FIG. 14, the energy recovery circuit 340 comprises a sustain discharge unit 342, a Y electrode charge/discharge unit 344, and an X electrode charge/discharge unit 346.

The sustain discharge unit 342, the Y electrode charge/discharge unit 344 and the X electrode charge/discharge unit 346 shown in FIG. 14 are quite similar in constituent components and operation to the sustain discharge unit 322, the Y electrode charge/discharge unit 324 and the X electrode charge/discharge unit 326 shown in FIG. 6. The difference is that variable voltages V_{yer2} and Vₓₑᵣ₂ are used instead of the capacitors C_{yer2} and Cₓₑᵣ₂.

The energy recovery circuit shown in FIG. 14 according to the fourth embodiment of the present invention regulates the charging/discharging currents of the capacitors by controlling the values of the variable voltages V_{yer2} and Vₓₑᵣ₂ while fixing the intervals where the gate signals of the energy recovery switches Yᵣ, Y_{f}, Xᵣ and X_{f} overlap those of the sustain switches Yₛ, Y_{g}, Xₛ and X_{g}, e.g., making the interval where the gate signals of the sustain switches Yₛ and X_{g} overlap those of the energy recovery switches Yᵣ, Y_{f}, Xᵣ and X_{f} equal to the interval where the gate signals of the sustain switches Xₛ and Y_{g} overlap those of the energy recovery switches Yᵣ, Y_{f}, Xᵣ and X_{f}.FIG. 15 illustrates an energy recovery circuit 360 according to a fifth embodiment of the present invention. Referring to FIG. 15, the energy recovery circuit 360 comprises a sustain discharge unit 362, a Y electrode charge/discharge unit 364, and an X electrode charge/discharge unit 366.

The sustain discharge unit 362, the Y electrode charge/discharge unit 364 and the X electrode charge/discharge unit 366 shown in FIG. 15 are quite similar in constituent components and operation to the sustain discharge unit 322, the Y electrode charge/discharge unit 324 and the X electrode charge/discharge unit 326 shown in FIG. 6. The difference is that the Y electrode charge/discharge unit 364 uses two inductors L3, L4 and the X electrode charge/discharge unit 366 uses two inductors L5, L6.

The Y electrode charge/discharge unit 324 and the X electrode charge/discharge unit 326 shown in FIG. 6 execute charging/discharging operation using energy stored in the single inductors L1, L2, respectively. The Y electrode charge/discharge unit 364 and the X electrode charge/discharge unit 366 shown in FIG. 15 execute charging operation using energy stored in the inductors L3, L5, respectively and execute discharging operation using energy stored in the inductors L4, L6, respectively

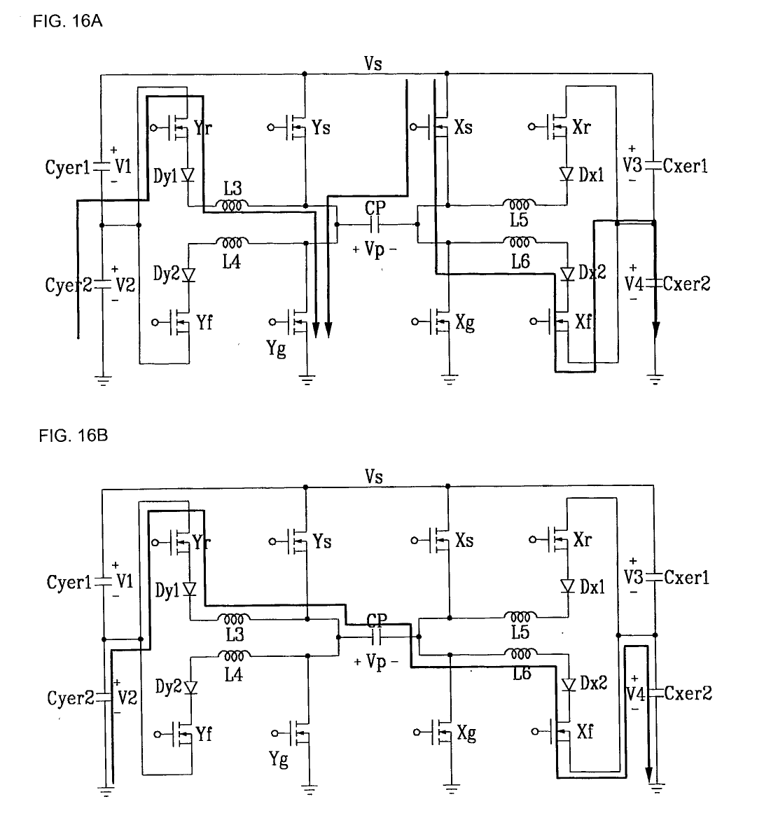

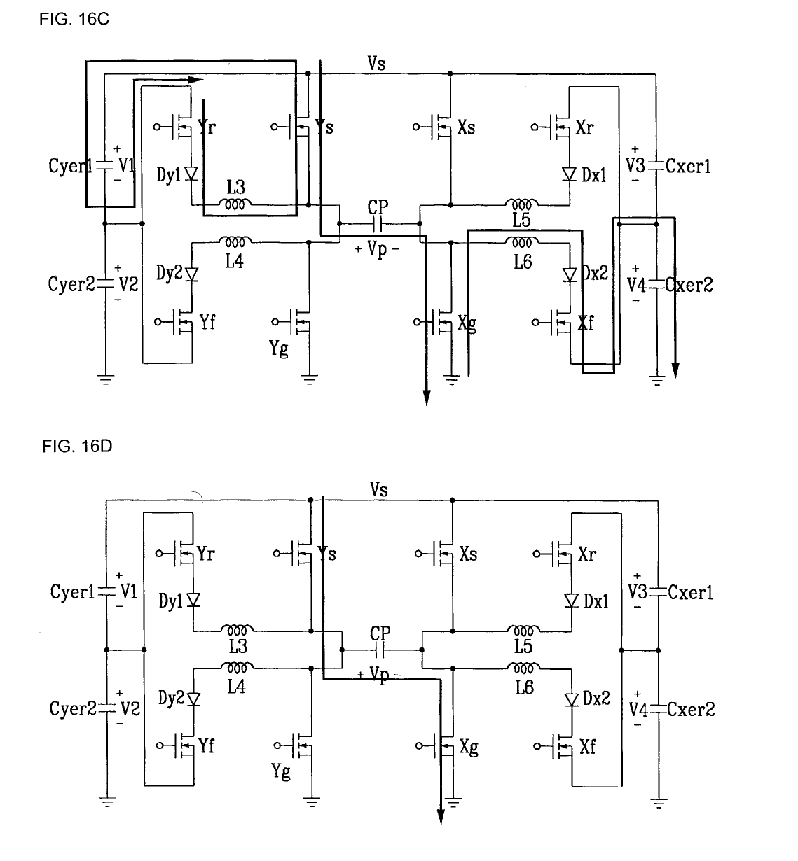

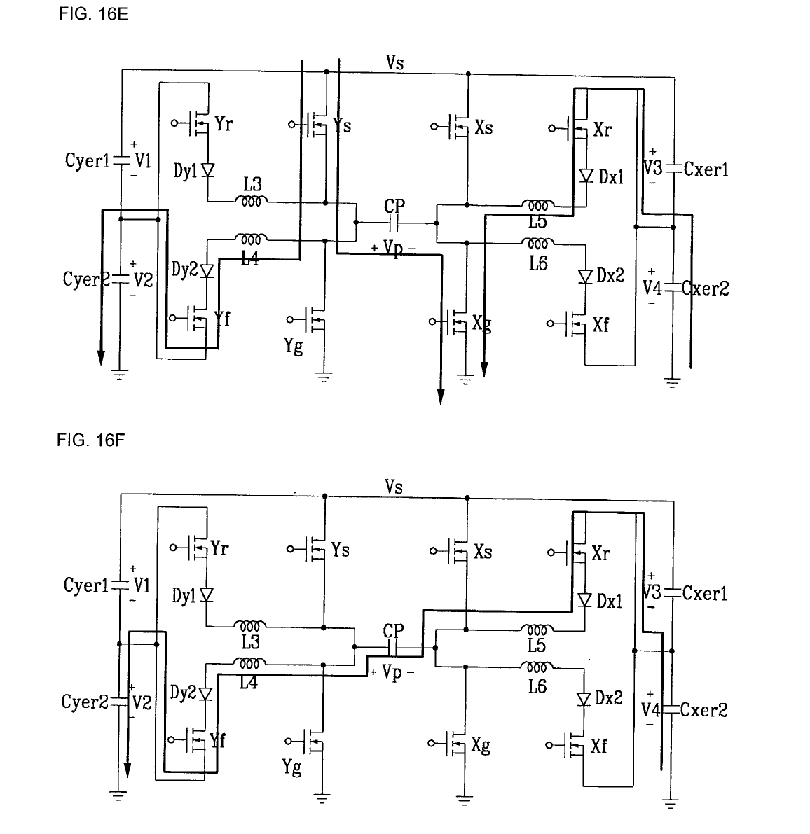

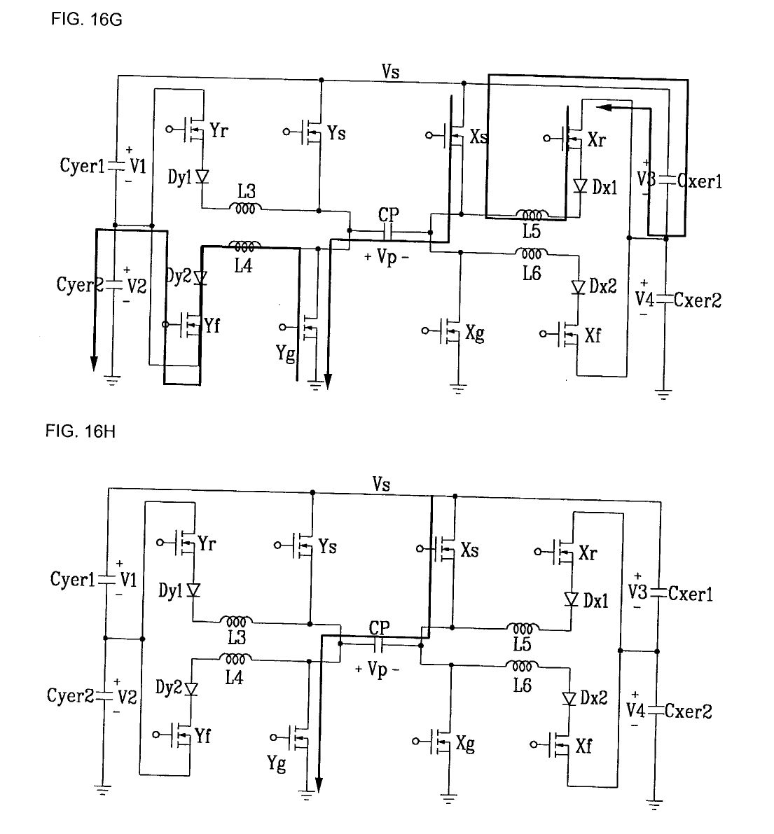

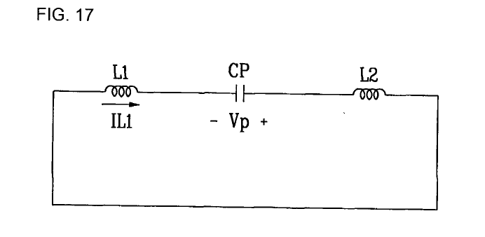

FIGS. 16A through 16H illustrate the current paths formed in the respective operation modes according to the fifth embodiment of the present invention shown in FIG. 15. A further detailed explanation for FIGS. 16A through 16H will be omitted because its operation is similar to those explained previously and it can easily be understood by those skilled in the technical field related to the present invention.

In the Y electrode charge/discharge unit 364 and the X electrode charge/discharge unit 366 shown in FIG. 15, the inductance of Inductors L3, L5 for charging operation may be different from the inductance of Inductors L4, L6 for discharging operation such that charging time of panel capacitance C_{P} may be different from the discharging time of panel capacitance.

According to the present invention, the required time (ΔT=t2−t1) for polarity inversion in the modes 2 and 6 can be calculated as follows.

First, the circuit state in mode 2 is modeled as shown FIG. 17 in order to determine the required time ΔT for polarity inversion. It is assumed that L1=L2=L, and V2=V4=V. At t=t1, the inductor current I_{L} and the terminal voltage V_{P} of the panel capacitor are Iₚₖ and V_{S}, respectively.

The inductor current Iₚₖ is given by Equation 1:

$${I}_{p k} = \frac{V}{L} Δ T \qquad [ Equation 1 ]$$

Based on this equivalent circuit, the required time ΔT for polarity inversion can be calculated as Equation 2:

$$Δ T = \sqrt{LC} [ {cos}^{- 1} \{ \frac{- {V}_{S}}{\sqrt{{V}_{S}^{2} + {( {ZI}_{p k} )}^{2}}} \} - {tan}^{- 1} \frac{{ZI}_{p k}}{{V}_{S}} ] \\ where \text{:} \\ Z = \sqrt{\frac{L}{{C}_{P}}} \qquad [ Equation 2 ]$$

As seen from Equation 2, the values of the inductors and the energy recovery capacitors are set to determine the required time for polarity inversion in the embodiment of the present invention. Accordingly, an appropriate selection of inductors and the energy recovery capacitors can shorten the rising/falling time of the panel voltage so that the panel performs a discharge in a sustain discharge interval except for at the panel voltage rising/falling interval.

While this invention has been described in connection with what is presently considered to be the most practical and preferred embodiment, it is to be understood that the invention is not limited to the disclosed embodiments, but is intended to cover various modifications and equivalent arrangements included within the spirit and scope of the appended claims.

For example, although the energy recovery circuit according to the embodiment of the present invention is a driver circuit for a PDP, it may also be an energy recovery circuit of a device having a capacitive load as well.

The present invention is not limited to the scan electrode driver or to the sustain electrode driver. It can also be used for the address driver. Also, more than one inductor can be used. For example, one inductor is used for discharge and the other inductor is used for charge.

As described above, the present invention allows zero-voltage switching despite the parasitic components of the circuit and prevents an inrush current from occurring at the start of a sustain discharge. Also, the present invention shortens the rising/falling time of the panel voltage without increasing the current flowing to the driving device so that the panel performs a discharge in the sustain interval except for at the rising and falling intervals of the panel voltage. Furthermore, an input voltage is divided and charged into the energy recovery capacitors when the circuit starts to operate, to apply the divided internal voltage of the energy recovery switch during the initial operation and use the switch of a low internal voltage, thereby reducing the cost and increasing the efficiency.

What is claimed is:

1. An apparatus for driving a plasma display panel comprising a pair of a scan electrode and a sustain electrode alternately disposed and a panel capacitor formed between the scan electrode and the sustain electrode, said apparatus comprising:
a sustain discharge unit comprising a first switch and a second switch serially connected between a first voltage and a second voltage and having a first contact connected to one terminal of the panel capacitor, and a third switch and a fourth switch serially connected between the first voltage and the second voltage and having a second contact connected to another terminal of the panel capacitor, said sustain discharge unit maintaining either terminal voltage of the panel capacitor at the first voltage or the second voltage;
a first charge/discharge unit comprising a first capacitor and a second capacitor serially connected between the first voltage and the second voltage, a fifth switch and a sixth switch respectively connected in parallel to a contact between the first capacitor and the second capacitor, and a first inductor connected to a contact between the fifth switch and the sixth switch and to the one terminal of the panel capacitor, said first charge/discharge unit charging the one terminal of the panel capacitor to the first voltage or discharging it to the second voltage; and
a second charge/discharge unit comprising a third capacitor and a fourth capacitor serially connected between the first voltage and the second voltage, a seventh switch and an eighth switch respectively connected in parallel to a contact between the third capacitor and the fourth capacitor, and a second inductor connected to a contact between the seventh switch and the eighth switch and to the other terminal of the panel capacitor, said second charge/discharge unit charging the other terminal of the panel capacitor to the first voltage or discharging it to the second voltage.

2. The apparatus as claimed in claim 1, wherein said first charge/discharge unit further comprises a first diode and a second diode respectively connected to the fifth switch and the sixth switch, for determining a path for current supply to the panel capacitor and a path for current recovery from the panel capacitor,
wherein said second charge/discharge unit further comprises a third diode and a fourth diode respectively connected to the seventh switch and the eighth switch for determining a path for current supply to the panel capacitor and a path for current recovery from the panel capacitor.

3. The apparatus as claimed in claim 1, wherein each of the first switch through the fourth switch comprises a transistor having a body diode.

4. The apparatus as claimed in claim 1, wherein the first voltage is a sustain discharge voltage and the second voltage is a ground voltage.

5. An apparatus for driving a plasma display panel comprising a pair of a scan electrode and a sustain electrode alternately disposed and a panel capacitor formed between the scan electrode and the sustain electrode, said apparatus comprising:
a sustain discharge unit comprising a first switch and a second switch serially connected between a first voltage and a second voltage and having a first contact connected to the one terminal of the panel capacitor, and a third switch and a fourth switch serially connected between the first voltage and the second voltage and having a second contact connected to the other terminal of the panel capacitor, said sustain discharge unit maintaining either terminal voltage of the panel capacitor at the first voltage or the second voltage;
a first charge/discharge unit comprising a first capacitor and a first variable voltage serially connected between the first voltage and the second voltage, a fifth switch and a sixth switch respectively connected in parallel to a contact between the first capacitor and the first variable voltage, and a first inductor connected to a contact between the fifth switch and the sixth switch and to one terminal of the panel capacitor, said first charge/discharge unit charging the one terminal of the panel capacitor to the first voltage or discharging it to the second voltage; and
a second charge/discharge unit comprising a second capacitor and a second variable voltage serially connected between the first voltage and the second voltage, a seventh switch and an eighth switch respectively connected in parallel to a contact between the second capacitor and the second variable voltage, and a second inductor connected to a contact between the seventh switch and the eighth switch and to the other terminal of the panel capacitor, said second charge/discharge unit charging another terminal of the panel capacitor to the first voltage or discharging it to the second voltage.

6. The apparatus as claimed in claim 5, wherein said first charge/discharge unit further comprises a first diode and a second diode respectively connected to the fifth switch and the sixth switch, for determining a path for current supply to the panel capacitor and a path for current recovery from the panel capacitor,
wherein said second charge/discharge unit further comprises a third diode and a fourth diode respectively connected to the seventh switch and the eighth switch, for determining a path for current supply to the panel capacitor and a path for current recovery from the panel capacitor.

7. The apparatus as claimed in claim 5, wherein each of the first switch through the fourth switch comprises a transistor having a body diode.

8. The apparatus as claimed in claim 5, wherein the first voltage is a sustain discharge voltage and the second voltage is a ground voltage.

9. An apparatus for driving a plasma display panel comprising a pair of a scan electrode and a sustain electrode alternately disposed and a panel capacitor formed between the scan electrode and the sustain electrode, said apparatus comprising:
a sustain discharge unit comprising a first switch and a second switch serially connected between a first voltage and a second voltage and having a first contact connected to one terminal of the panel capacitor, and a third switch and a fourth switch serially connected between the first voltage and the second voltage and having a second contact connected to another terminal of the panel capacitor, said sustain discharge unit maintaining either terminal voltage of the panel capacitor at the first voltage or the second voltage; and
a charge/discharge unit comprising a first inductor and a second inductor electrically connected to the one terminal and the other terminal of the panel capacitor, respectively,
wherein said charge/discharge unit boosts a current to store an energy in the first inductor and the second inductor while either terminal voltage of the panel capacitor is maintained at a sustain discharge voltage, and inverts the polarity of either terminal voltage of the panel capacitor using the energy stored in the first inductor and the second inductor.

10. The apparatus as claimed in claim 9, wherein each of the first switch through the fourth switch comprises a transistor having a body diode.

11. The apparatus as claimed in claim 10, wherein said charge/discharge unit performs zero-voltage switching of the first switch through the fourth switch using the energy stored in the first inductor and the second inductor after inverting the polarity of either terminal voltage of the panel capacitor.

12. The apparatus as claimed in claim 10, wherein said charge/discharge unit comprises:
a first charge/discharge unit comprising a first energy recovery capacitor and a second energy recovery capacitor serially connected between the first voltage and the second voltage, for energy supply to the panel capacitor or energy recovery from the panel capacitor, and a fifth switch and a sixth switch respectively connected in parallel between the first inductor and a contact between the first energy recovery capacitor and the second energy recovery capacitor, for performing a switching operation to raise the one terminal voltage of the panel capacitor to the first voltage or drop it to the second voltage; and
a second charge/discharge unit comprising a third energy recovery capacitor and a fourth energy recovery capacitor serially connected between the first voltage and the second voltage, for energy supply to the panel capacitor or energy recovery from the panel capacitor, and a seventh switch and an eighth switch respectively connected in parallel between the second inductor and a contact between the third energy recovery capacitor and the fourth energy recovery capacitor, for performing a switching operation to raise the other terminal voltage of the panel capacitor to the first voltage or drop it to the second voltage.

13. The apparatus as claimed in claim 9, wherein the first voltage is a sustain discharge voltage and the second voltage is a ground voltage.

14. The apparatus as claimed in claim 10, wherein said charge/discharge unit comprises:
a first charge/discharge unit comprising a first capacitor and a first variable voltage serially connected between the first voltage and the second voltage, and a fifth switch and a sixth switch respectively connected in parallel between the first inductor and a contact between the first capacitor and the first variable voltage, said first charge/discharge unit charging the one terminal of the panel capacitor to the first voltage or discharging it to the second voltage; and
a second charge/discharge unit comprising a second capacitor and a second variable voltage serially connected between the first voltage and the second voltage, and a seventh switch and an eighth switch respectively connected in parallel between the second inductor and a contact between the second capacitor and the second variable voltage, said second charge/discharge unit charging the other terminal of the panel capacitor to the first voltage or discharging it to the second voltage.

15. A plasma display panel, comprising:
a panel comprising a plurality of address electrodes, a plurality of a pair of a scan electrode and a sustain electrode alternately arranged, and a panel capacitor formed between the scan electrode and the sustain electrode;
a controller for receiving an external image signal, and generating an address drive control signal and a sustain discharge signal;
an address driver that receives the address drive control signal from the controller and applies a display data signal to the address electrode; and
a scan/sustain driver that receives the sustain discharge signal from the controller and applies a sustain discharge voltage alternately to the scan electrodes and the sustain electrodes,
wherein said scan/sustain driver comprises:
a sustain discharge unit comprising a first switch and a second switch serially connected between a first voltage and a second voltage and having a first contact connected to the one terminal of the panel capacitor, and a third switch and a fourth switch serially connected between the first voltage and the second voltage and having a second contact connected to the other terminal of the panel capacitor, the sustain discharge unit maintaining either terminal voltage of the panel capacitor at the first voltage or the second voltage; and
a charge/discharge unit comprising a first inductor and a second inductor electrically connected to the one terminal and the other terminal of the panel capacitor, respectively, the charge/discharge unit boosting a current to a predetermined level for a later sustain discharge to store an energy in the first inductor and the second inductor while either terminal voltage of the panel capacitor is maintained at the sustain discharge voltage, the charge/discharge unit inverting the polarity of either terminal voltage of the panel capacitor using the energy stored in the first inductor and the second inductor.

16. The plasma display panel as claimed in claim 15, wherein each of the first switch through the fourth switch comprises a transistor having a body diode.

17. The plasma display panel as claimed in claim 16, wherein the charge/discharge unit performs zero-voltage switching of the first switch through the fourth switch using the energy stored in the first inductor and the second inductor after inverting the polarity of either terminal voltage of the panel capacitor.

18. A method for driving a plasma display panel comprising a pair of a scan electrode and a sustain electrode alternately disposed and a panel capacitor formed between the scan electrode and the sustain electrode, said method comprising steps of:
boosting a current flowing to a first inductor and a second inductor electrically connected to one terminal and another terminal of the panel capacitor, respectively, to store an energy in the first inductor and the second inductor, while both terminal voltage of the panel capacitor is maintained at a sustain discharge voltage having a first polarity;
inverting the polarity of both terminal voltage of the panel capacitor using the energy stored in the first inductor and the second inductor; and
maintaining both terminal voltage of the panel capacitor at the sustain discharge voltage having the second polarity.

19. The method of claim 18, wherein the first inductor and the second inductor still contain energy, even after the panel capacitor is fully charged.

20. The method of claim 19, further comprising a step of recovering the energy stored in the first inductor and the second inductor while both terminal voltage of the panel capacitor is changed to a sustain discharge voltage having a second polarity opposite to the first polarity; and

21. The method as claimed in claim 18, wherein the plasma display panel comprises:
a sustain discharge unit comprising a first switch and a second switch serially connected between a first voltage and a second voltage and having a contact connected to the one terminal of the panel capacitor, and a third switch and a fourth switch serially connected between the first voltage and the second voltage and having a contact connected to the other terminal of the panel capacitor, the sustain discharge unit maintaining a terminal voltage of the panel capacitor at the first voltage or the second voltage;
wherein the step of recovering the energy comprises performing zero-voltage switching of the first switch through the fourth switch using the energy stored in the first inductor and the second inductor after both terminal voltage of the panel capacitor is changed to the sustain discharge voltage having the second polarity.

22. A method for driving a plasma display panel having an apparatus for driving a plasma display panel comprising a pair of a scan electrode and a sustain electrode alternately disposed and a panel capacitor formed between the scan electrode and the sustain electrode, comprising: a sustain discharge unit comprising a first switch and a second switch serially connected between a first voltage and a second voltage and having a first contact connected to one terminal of the panel capacitor, and a third switch and a fourth switch serially connected between the first voltage and the second voltage and having a second contact connected to another terminal of the panel capacitor, said sustain discharge unit maintaining either terminal voltage of the panel capacitor at the first voltage or the second voltage; a first charge/discharge unit comprising a first capacitor and a second capacitor serially connected between the first voltage and the second voltage, a fifth switch and a sixth switch respectively connected in parallel to a contact between the first capacitor and the second capacitor, and a first inductor connected to a contact between the fifth switch and the sixth switch and to the one terminal of the panel capacitor, said first charge/discharge unit charging the one terminal of the panel capacitor to the first voltage or discharging it to the second voltage; and a second charge/discharge unit comprising a third capacitor and a fourth capacitor serially connected between the first voltage and the second voltage, a seventh switch and an eighth switch respectively connected in parallel to a contact between the third capacitor and the fourth capacitor, and a second inductor connected to a contact between the seventh switch and the eighth switch and to the other terminal of the panel capacitor, said second charge/discharge unit charging the other terminal of the panel capacitor to the first voltage or discharging it to the second voltage, said method comprising steps of:
turning the second and third switches ON, and maintaining the one terminal voltage of the panel capacitor to the second voltage and the other terminal of the panel capacitor to the first voltage;
turning the fifth and eighth switches ON while the second switch and the third switch are ON, and storing an energy in the first inductor and the second inductor;
turning the second switch and the third switch OFF while the fifth switch and the eighth switch are ON, and inverting the polarity of both terminal voltage of the panel capacitor;
turning the first switch and the fourth switch ON while the fifth switch and the eighth switch are ON, and recovering the energy stored in the first inductor and the second inductor; and
turning the fifth switch and the eighth switch OFF while the first switch and the fourth switch are ON, and maintaining the one terminal voltage of the panel capacitor at the first voltage and the other terminal of the panel capacitor at the second voltages.

23. The method as claimed in claim 22, wherein an interval where the second switch and the third switch are ON simultaneously with the fifth switch is equal to an interval where the second switch and the third switch are ON simultaneously with the eighth switch.

24. The method as claimed in claim 22, wherein an interval where the second switch and the third switch are ON simultaneously with the fifth switch is longer than an interval where the second switch and the third switch are ON simultaneously with the eighth switch.

25. The method as claimed in claim 22, wherein an interval where the second switch and the third switch are ON simultaneously with the fifth switch is shorter than an interval where the second switch and the third switch are ON simultaneously with the eighth switch.

26. A method for driving a plasma display panel, having a panel capacitor with a terminal and at least one inductor electrically coupled to the terminal, comprising steps of:
applying a current of a first polarity to the inductor while holding the terminal at a first voltage level in order to store first energy in the inductor;
boosting the terminal voltage level to a second voltage level using the first energy stored in the inductor;
applying a current of a second polarity opposite to the first polarity to the inductor while holding the terminal at the second voltage level in order to store second energy in the inductor; and
discharging the capacitor terminal voltage from the second voltage level to the first voltage level using the second energy stored in the inductor.

27. The method of claim 26, wherein the inductor still contains energy, even after the terminal voltage level is boosted to the second voltage level.

28. The method of claim 27, further comprising a step of:
recovering the remaining energy from the inductor when the terminal voltage level is boosted to the second voltage level.

29. The method of claim 28, further comprising a step of:
supplying continuously to the capacitor the second voltage level from an external source after the terminal voltage level is boosted to the second voltage level.

30. The method of claim 26, wherein the first energy and the second energy are stored in the same inductor.

31. The method of claim 27, wherein the first energy and the second energy are stored in different inductors.
